(19) United States
(12) Patent Application Publication
(10) Pub. No.: US 2013/0191150 A1
(43) Pub. Date: Jul. 25, 2013

(54) MEDICAL EXAMINATION SCHEDULING SYSTEM AND ASSOCIATED METHODS

(71) Applicants: Jack Jacob, Anchorage, AK (US); Robert Wendell Arnold, Anchorage, AK (US)

(72) Inventors: Jack Jacob, Anchorage, AK (US); Robert Wendell Arnold, Anchorage, AK (US)

(73) Assignee: GLACIER MEDICAL SOFTWARE, INC., Anchorage, AK (US)

(21) Appl. No.: 13/358,274

(22) Filed: Jan. 25, 2012

(51) Int. Cl. G06Q 50/24

(52) U.S. Cl. 705/3

(57) ABSTRACT

A system and computer implemented method is provided to determine a need for a medical examination. The system includes a computerized device and a database accessible using an interface. Some data may include information about a patient that may be definable by a user. The system may also include a rules engine operated by the computerized device to manage rules and to retrieve the data from the database, retrieve the rules stored in the database relating to the need for the examination of the medical condition by a specialist practitioner, and compare the data that is retrieved with the rules to determine a need for an initial examination. Findings from the initial examination are storable in the database, and the findings are retrievable to be compared with the rules to determine a need for a subsequent examination. Medical codes associated with the findings are storable in the database

### FIELD OF THE INVENTION

The present invention relates generally to a system for scheduling medical appointments based on patient medical data.

### BACKGROUND OF THE INVENTION

Retinopathy of prematurity (ROP) is a progressive eye disease that affects babies that have been born prematurely. ROP involves abnormal growth of blood vessels in the eye, which may lead to scarring of tissue and retinal detachment. Blood vessels grow properly within a mother's womb, but sometimes do not grow properly outside of the womb. If left untreated, ROP may cause permanent visual impairment or blindness for the baby. If the diagnosis of ROP is not made in a timely manner due to missed or delayed detection, treatment may not be effective and may result in blindness. As an example, Stevie Wonder is blind from ROP.

Screening for detection and treatment of ROP typically occurs in a neonatal intensive care unit (NICU). A NICU is a facility within a hospital that is designed to give very special medical care to premature infants. Here, patients weighing as little as one pound may be kept in incubators. Some NICUs are large and may have seventy or more beds/incubators. Though all the NICU beds may be occupied, not all of those patients may need ROP examination follow-up. The selective nature of babies that may need ROP follow-up exams means that the NICU is often tasked with the burden of tracking babies needing an exam and ensuring that the exam is performed on time. This is typically managed by using paper documents, though some NICUs have created an internal process that uses Excel or non-enterprise databases such as Access. In addition, patients needing ROP care are frequently transferred to another NICU. During this process, the information for their next appointment may be lost which can result in a missed exam.

ROP patients are typically examined by two different types of medical specialists—a neonatologist and a pediatric ophthalmologist. In the NICU, a neonatologist is a doctor in charge of the NICU. He or she specializes in taking care of the patients in the NICU and making sure they get the care they need. The neonatologist is not qualified to treat ROP, but is still responsible for making sure the patient receives ROP care. The neonatologist typically logs activity of the NICU and remains informed about the condition of the ROP patients. The NICU nurse(s) coordinates ROP examinations and helps the other doctors with caring for the patients.

A pediatric ophthalmologist administers the ROP examinations to the patients in the NICU. A pediatric ophthalmologist is in the sub-specialty of ophthalmology concerned with eye diseases and vision care in children. Very few pediatric ophthalmologists accept ROP patients. The pediatric ophthalmologist is usually not a direct employee of the hospital, but rather operates his or her own practice, subcontracting services to the NICU. The pediatric ophthalmologist typically visits the NICU one day a week to examine or treat patients, but is otherwise not present day-to-day.

Due to the critical nature of administering an ROP examination to the necessary patients within a timeframe relevant to diagnosing and treating the disease, accurate and timely scheduling of such examinations is of extreme importance. If an appointment is missed or not scheduled, the doctor and/or the hospital may be exposed substantial claims of medical malpractice.

Errors may sometimes occur due to the mishandling of patient files and missed scheduling of patient exams. Since the pediatric ophthalmologist is typically at the NICU one day a week, he or she has to rely on the NICU staff to properly schedule ROP examinations. If the NICU misplaces a sheet of paper or fails to inform the pediatric ophthalmologist that a new patient needs an examination, it is possible that patient will not be examined on time or perhaps never be examined at all, which leads to potentially catastrophic results.

Typically in such a medical malpractice lawsuit, the pediatric ophthalmologist who has been involved in the patient's care and the hospital are blamed. This is true even when the pediatric ophthalmologist is not responsible for the adverse outcome. For example, in one situation the inventors are aware of the NICU discharged the premature baby with instructions to seek follow-up examination relative to ROP. The parents never sought follow-up treatment and the baby ultimately went blind. In the trial the jury found the pediatric ophthalmologist liable. In this case not only has the pediatric ophthalmologist been accused for a system failure, the hospital and neonatologists also were located. Perhaps worst of all, the child is now permanently sightless. The current handling of ROP diagnosis and follow-up care is incapable of addressing system failures or failures on the part of one or more of the participants (i.e., nurses, doctors, parents, etc.)

The medico-legal changes in the climate of ROP care in the last twenty years have led to a shortage of qualified physicians willing to treat ROP. At the same time, more premature births are occurring worldwide. These two facts contribute to what is being called the ROP ophthalmology crisis, in which there are more patients in need of ROP care but fewer physicians available to examine and treat the disease. In a time where the availability of improved guidelines and treatments should be contributing to the eradication of ROP, these efforts are being stifled by contentious lawsuits. The need for an invention that reduces liability is greater than ever.

A number of proposed solutions exist to provide scheduling for a medical examination and administering medical treatment in the general practice of medicine. However, no solutions exist that include rules with high applicability to the examinations that occur in a NICU. More specifically, known solutions do not contemplate the urgency and scheduling requirements associated with ROP in infant patients, making them incapable of providing a reliable, redundant solution with fail safe mechanisms unique to the issues surrounding permanent loss of sight associated with ROP.

In fact, while medical triage systems based on a rules engine are known to exist, the algorithms of these known solutions lack the configurability necessary to account for the conditions relating to ROP. Additionally, these prior disclosures fail to account for scenarios wherein the decisions of a medical practitioner may be necessary to determine whether the scheduling of a patient for an exam is required, which may relate to ROP.

Furthermore, known solutions lack the incorporation of local rules. Still further, known solutions additionally lack the ability to efficiently and effectively track an infant patient as he or she may move to another medical care facility or be discharged. This deficiency which is particularly critical when dealing with ROP because it is frequently the failure to follow-up after discharge from NICU that leads to catastrophic results. Further still, known solutions do not envision the peculiar situation presented with such a highly specialized disease as ROP; namely, the vast majority of time an infant patient is in the NICU they will be there without anyone present capable of diagnosing or treating ROP, which makes system and/or scheduling failures all the more catastrophic.

What is needed is a medical examination scheduling system that can be used to compare data with information relating to a patient with rules to determine whether an initial examination is necessary. Additionally, a system is needed to record the findings of the initial examination, wherein the system can analyze with the rules to determine whether a subsequent examination is necessary. Furthermore, a system is needed to schedule examinations that are necessary and follow-up with a patient after he or she has been discharged from a NICU. Moreover, a system is needed to track communication with a patient after being discharged, scheduling follow-up examinations as may be necessary. Also, to enable researchers trying to advance the treatment of ROP disease, the solution should be software based and allow the collection and organization of ROP data from an infinite number of separate facilities into a central, queryable repository.

### SUMMARY OF THE INVENTION

Various embodiments of the present invention provide a medical examination scheduling system that can be used to compare data with information relating to a patient with rules to determine whether an initial examination is necessary. Additionally, the present invention provides a system to record the findings of the initial examination, which can be analyzed with the rules to determine whether a subsequent and/or follow-up examination is necessary. Furthermore, the system may schedule examinations that are necessary and follow-up with a patient after he or she has been discharged from a NICU. Also, the system of the present invention assists researchers trying to advance the treatment of ROP disease. The system of the present invention may be software based, facilitating the collection and organization of ROP data from an infinite number of separate facilities into a central, repository that may be queried.

During a typical week, new NICU babies are admitted, some of which have life threatening medical conditions. The babies may be patients with a medical condition that have a need for examination. The substantive expert, the pediatric ophthalmologist, is busy with his/her private practice and typically on-site in the NICU 5% of the time (or less). This requires the specialist practitioner, such as a pediatric ophthalmologist, to rely on the NICU staff, so if the NICU staff fails to relay accurate patient data to him/her, catastrophic results can result.

Generally speaking, the invention system and associated computer implemented method facilitates the accurate communication of patient data between the NICU and the pediatric ophthalmologist. It uses the admission guidelines rules engine to ensure that every baby which should receive an initial ROP screening is scheduled appropriately by comparing rules included in a database with information about the patient. Rules and data included in the database may be accessible over a network

According to an embodiment of the presenting invention, a method is described for determining a need for an examination for a medical condition. The medical condition may relate to retinopathy of prematurity. The method may initially comprise retrieving data from a database including information about a patient. At least part of the information about the patient included in the database may be definable by the user.

Additionally, the method may comprise retrieving rules stored in the database relating to the need for the examination by a specialist practitioner. The data and the rules may be compared by a rules engine to determine whether there exists a need for an initial examination. The information may be compared to the rules to determine whether the initial examination is necessary includes birth weight and gestational age.

Determining whether a need for the initial examination exists may include making a determination of the need for the initial examination, a determination of no need for the initial examination, or a determination of a possible need for the initial examination. The determination of the need for the initial examination is defined as results of a comparison of the data and the rules being below a first threshold level, resulting in the initial examination being scheduled. Conversely, a determination of no need for the initial examination may be defined as the results of the comparison of the data and the rules being above a second threshold level, resulting in no initial examination being scheduled.

The determination of the possible need for the initial examination may be defined as the results of the comparison of the data and the rules resulting between the first threshold level and the second threshold level. These results may indicate a possible need for the initial examination. The possible need for a medical examination may be presented to a medical professional to decide whether the initial examination should be scheduled.

After an initial examination has been conducted, findings from the initial examination are storable in the database. The findings from the initial examination are retrievable from the database to be compared with the rules to determine a need for a subsequent examination. Information that may be compared to the rules to determine whether the subsequent examination is necessary relate to the medical condition by stage, zone, and plus.

Determining the need for the subsequent examination may include making at least one of a determination of the need for the subsequent examination, a determination of no need for the subsequent examination, and the determination of a possible need for the subsequent examination.

Determination of the need for the subsequent examination may be defined as results of the comparison of the findings from the initial examination and the rules being below a first threshold level. This finding may result in a subsequent examination being scheduled. Conversely, the determination of no need for the subsequent examination is defined as the results of the comparison of the findings from the initial examination and the rules being above a second threshold level, resulting in no subsequent examination being scheduled

The determination of the possible need for the subsequent examination is defined as the results of the comparison of the findings from the initial examination and the rules being between the first threshold level and the second threshold level. This may result in a presentation of the determination of the possible need for the subsequent examination to the medical professional to decide whether the initial examination should be scheduled.

According to an embodiment of the present invention, findings from the subsequent examination are storable in the database. Additionally, medical codes may be associated with the findings, which may also be storable in the database. The rules may be managed by the rules engine operated on a computerized device with a processor and memory. At least part of the data may be accessible using an interface.

According to an embodiment of the present invention, the patient may be selectively discharged following the examination. The findings may be compared with the rules to determine whether a follow-up examination is necessary for the patient that has been discharged. If the follow-up examination is necessary, it may be scheduled for the patient that has been discharged. A follow-up examination that is possibly necessary may be presented to the medical professional to decide wither the follow-up examination should be scheduled.

According to an embodiment of the present invention, a follow-up communication may be generated for the patient that has been discharged. A response to the follow-up communication may be recordable in the database.

According to an embodiment of the present invention, scheduling the examination may occur substantially automatically. The examination may include the initial examination or the subsequent examination. In this embodiment, scheduling of an examination may begin with accessing a schedule from the database. A range of available openings for the examination may then be determined

Next, a priority for the patient may be determined. The range of available openings may then be compared with the priority to determine an appointment for the examination. The scheduling operation may conclude with scheduling the examination at the appointment.

According to an embodiment of the present invention, at least part of the database is accessible over a network. Also, custom rules may be definable to supplement the rules. The custom rules may be compared with the data to affect determining whether the examination is necessary. The custom rules could be storable in the database. The custom rules may relate to a geographic location of the patient.

According to an embodiment of the present invention, an alert generated from comparing the data with the rules is transmittable using the interface. The alert may inform the user that the examination is necessary for the patient. Additionally, reports may be selectively generated to include data relating to the patient and the findings.

According to an embodiment of the present invention, the data relating to the patient and the findings may be transferable to an alternate practitioner, and wherein the data that is transferred is selectively monitored and recordable in the database.

Still further, the invention in certain embodiments allows for updating and recalibrating of the subsequent and/or follow-up examination time table based on additional inputs by a pediatric ophthalmologist or even by those other than the pediatric ophthalmologist, such as NICU staff.

In the case of geolocation or ethnicity specific risk factors, the NICU may customize guidelines to account for localized issues, such as differences in how babies are cared for locally or known nutrient deficiencies found in certain ethnicity groups, for example. These abilities are unique contributions this software invention brings to the landscape of ROP care.

Beyond mere screening and scheduling, however, the system may operate as a central repository of all the patient's ROP information so the NICU staffs remain notified of the patient's ROP status and progress. Additionally, the system may have a built in fail safe that graphically highlights for users when an infant patient has been entered to the system, requires follow-up care and has not been scheduled an appointment.

According to another embodiment of the present invention, the system may enable an ophthalmologist to record the results of the exam electronically. More specifically, the system may provide an interface to draw the retina onto the computerized exam form, for example, using a mouse or stylus. Alternatively, a user may upload a photographic image of the retina to be saved with the exam record.

Another advantage of the invention is configurability to take into account known or later discovered anomalies that affect an appropriate and prudent treatment plan. For example, in India ROP is more common in babies weighing 2000 grams than it is in the United States. Thus the system of the present invention is, in certain embodiments, may be configured to rely upon geo-location data to select the appropriate rules engine suitable for the specific geographical location.

Furthermore, the present invention system and associated computer implemented may method provide the NICU, and thereby the hospital more generally, with a form of medical malpractice defense. Similarly, the pediatric ophthalmologist contracting with the hospital may be provided a form of medical malpractice defense. This is because, generally speaking, medical malpractice is legally found when there has been a deviation in the standard of care associated with delivery of a particular medical service. In the scenario where medical malpractice has been found relative to the permanent loss of sight caused by ROP there has been a system failure or participant failure.

By having a rules engine focusing on the peculiar issues presented by ROP the system and associated methods may act to make sure that medical personnel tasked with scheduling and administering medical examinations are well informed of which patients may require the examinations. This is particularly critical in a scenario where the specialist is present only one day a week and other nurses and doctors attending the NICU are not specifically trained to diagnose, treat and monitor with ROP. By implementing the invention, a non-expert ROP medical staff can use the system to reduce the risk of missing a necessary medical examination. Essentially, by having this system in place, a state of the art triage, diagnosis, tracking and follow-up can be provided with triggers and alerts being given in the event that a milestone of one kind or another (i.e., patient status, examinations, etc.) has not be timely achieved.

Further still, in certain embodiments the invention provides for a two-way data exchange between the database(s) of the invention and other systems, which may allow for easy integration into larger hospital, insurance company or government databases. With or without combining the invention's data repository with the hospital's data system, the invention allows the hospital the ability to use real time, automated queries to alert the hospital staff of a potential health emergency, such as discharging a patient with advanced ROP, though this feature may be further enhanced when combined with the hospital's full electronic patient record.

Still further, in certain embodiments the invention process associates an appropriate plan for follow-up visits and treatment as dictated by the treating physician or healthcare system. In fact, this ability is encapsulated in a robust outpatient feature that allows continuity of care from the time the patient was examined in the NICU to after the patient has been discharged and is being seen by a new pediatric ophthalmologist.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and may fully convey the full scope of the invention to those skilled in the art.

### BRIEF DESCRIPTION OF THE DRAWINGS

FIG. 1 shows a system for medical examination scheduling for neonatal intensive care unit, according to an embodiment of the present invention.

FIG. 2 shows a basic overview of the system, according to an embodiment of the present invention.

FIG. 3 shows a more detailed overview of the system, according to an embodiment of the present invention.

FIG. 4 shows a detailed overview of one particular aspect of the system, according to an embodiment of the present invention.

FIG. 5 shows a detailed overview of one particular aspect of the system, according to an embodiment of the present invention.

FIG. 6 shows an illustrated screenshot depicting how examination results are entered into the system, according to an embodiment of the present invention.

FIG. 7 shows a specific computer device capable of performing one or more computer-implemented steps in practicing the method aspects of the present invention, according to an embodiment of the present invention.

### DETAILED DESCRIPTION OF THE INVENTION

The invention relates to a computerized process for the scheduling, tracking, documenting and billing of retinopathy of prematurity (ROP) eye examinations in the neonatal intensive care unit (NICU), which substantially increases the likelihood that all patients receive the recommended medical care they need in a timely manner, thereby significantly reducing the risk of blindness due to missed or late eye examinations. This computerized process is embodied by software that can be used to determine either an initial eye examination date or lack of necessity for an initial eye examination. This determination may be made based on a configurable rules engine that considers the age and weight of the baby. The system may also electronically record results of eye examinations for quick retrieval and reporting purposes. Additionally, the system may determine whether a subsequent examination may be necessary. A treatment date may be determined and scheduled based on analysis performed by a rules engine that computes the next appointment date using the results from previously administered examinations. This ensures that all patients that need an appointment have one, thereby substantially reducing the likelihood of consequences (i.e., permanent blindness) and decreasing medical malpractice claims related to allegations that the patient should have been examined, but was not examined. The invention also protects against inaction of the participants (i.e., nurses, doctors, parents, etc.) by facilitating the transfer of documents, including scheduling, which ensures a seamless follow-up process so that patients requiring future medical care and screening, such as by an alternate practitioner, may be evaluated in a timely manner even after leaving the NICU.

More specifically, the present system and associated computer implemented methods advantageously address the deficiencies of known solutions by providing a medical examination scheduling system that can be used to compare data relating to a medical condition or procedure with information relating to a patient with rules to determine whether an initial examination is necessary. Additionally, the system of the present invention may record the findings of the initial examination, which the system can analyze with the rules to determine whether a subsequent examination is necessary. A subsequent examination may be given after the initial examination, but before the patient is discharged. Furthermore, the system of the present invention may schedule follow-up examinations that are necessary and follow-up with a patient after he or she has been discharged from a NICU. A patient may selectively be discharged upon the determination of the system and/or medical practitioner.

The system of the present invention may additionally facilitate communication between the NICU and a specialist practitioner, such as a pediatric ophthalmologist. The system of the present invention may use a rules engine to ensure substantially every patient with a need for an examination is scheduled for an examination and may trigger reminders and scheduling notices to prevent participants from failing to follow-up in an appropriate manner. In summary, the system facilitates the organization and administration of medical care while a patient is in the NICU, transferred to a different NICU, and once the patient has left the NICU.

The date an infant patient receives an initial examination for ROP is critical because it shouldn't be performed too early (which is considered to be an unnecessary or unwarranted exam), nor can it be performed too late, which could result in failure of treatment. Generally speaking, the guidelines from the American Academy of Pediatrics (hereinafter the AAP Guidelines) set the standard relative to which infant patients require an ROP examination. Having said that, although the AAP Guidelines are internationally recognized as the standard, some hospitals and doctors use their own variation of the guidelines, many times being more strict so as to make sure that no infant patient falls through the cracks, so to speak. Thus, the invention system and associated computer implemented process employs a configurable rules engine based on the AAP Guidelines, but fully customizable to incorporate the particular variations desired by the hospital, NICU or contracting pediatric ophthalmologist, for both domestic and international facilities.

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

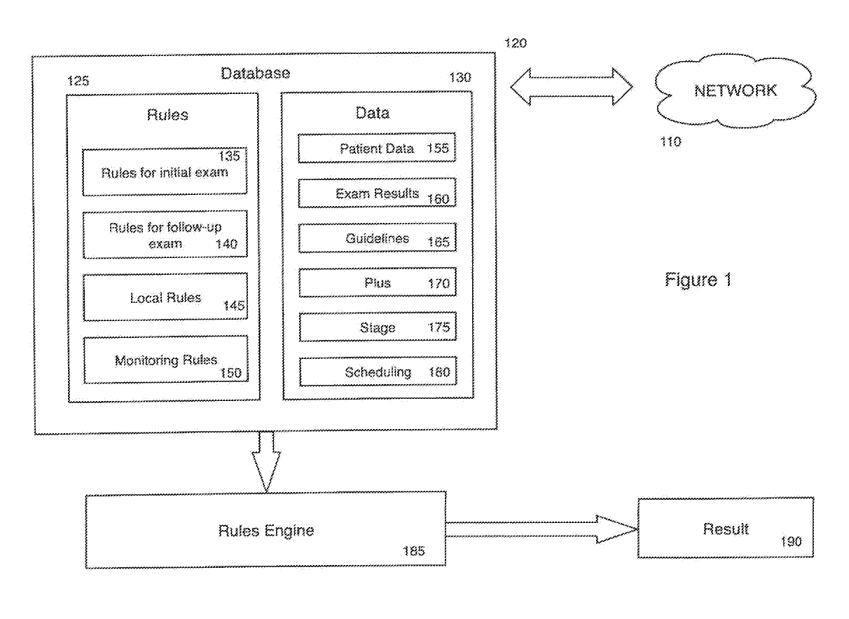

Referring now to FIG. 1, a system for medial examination scheduling for neonatal intensive care will now be discussed, according to an embodiment of the present invention. More specifically, a database 120 and rules engine 185 included in the system will now be discussed. The database 120 may be included in the memory of the system to store and provide access to information used for operating the system. The information stored in the database 120 may include rules 125 and data 130. A person of skill in the art will appreciate that additional information may be included in the database 120, and should not view the database 120 as being limited solely rules 125 and data 130. Examples of additional information storable in the database 120 may include operational information related to medical practitioners, geographic location information, computer code usable to operate the system, and a plethora of other items that may be digitally represented and storable in the memory.

Data 130 may be included in the database 120 relating to information to be analyzed for determining a result 190. More specifically, the data 130 may include patient data 155 to identify a patient. Examples of patient data may include, without limitation, personal information, health records, and other information that may be associated with the patient. Examination results 190 of an initial or subsequent examination may also be included as data 130. Guidelines 165 may be included as data 130, which may relate to the determination of whether an examination should be scheduled. Guidelines 165 may be adaptable to a specific medical facility or geographic location. Moreover, guidelines 165 may be based or derived from standardized guidelines, such as provided by the American Academy of Pediatrics.

An additional consideration is the fact that insurance companies will not pay for what they deem to be an unnecessary or unwarranted screening, including screening for an ailment as severe as ROP. Thus, the date of the first examination is ordinarily determined based on the infant patient's birth weight (BW) and/or gestational age (GA). Essentially, an infant with a GA of 33 weeks or less should ordinarily receive an initial ROP exam unless the weight of the infant patient is above 2000 grams. Similarly, an infant patient weighing 1500 grams or less should ordinarily receive an initial ROP examination.

In the situation where an infant patient has a BW of between 1500 grams and 2000 grams the invention would flag the file and the pediatric ophthalmologist or other NICU staff would look to the medical history to see if there are other known risk factors, such as the mother having used drugs during pregnancy, which would place the infant patient at a higher risk for ROP. The findings of the initial examination are storable in a database, which may be accessible to determine whether a subsequent examination should be scheduled.

For a subsequent examination, however, it is not the BW or GA that matters, but rather the stage, zone and plus that matters. Similarly, the stage, zone, and plus observed during the subsequent examination may be analyzed to determine whether a follow-up examination will be required.

The stage is the severity of the disease, which can be either 1, 2, 3 or 4, with stage 4 being worst and stage 1 being least advanced ROP. The zone refers to different concentric areas of the retina around the optic nerve. Zone 1 being nearest to the optic nerve and zone 3 being the farthest away. The reference to the zone on an ROP exam refers to how far into the peripheral area of the retina that the blood vessels have grown into. Plus is a sign of abnormal blood vessel growth and refers to how tortuous the blood vessels are. For example, if the patient has stage 1, and zone 2, a follow-up examination is indicated for 2 weeks. With this in mind, the invention looks at the exam results (stage, zone, plus) that the pediatric ophthalmologist entered and makes sure the next exam date is within the guidelines.

Data 130 relating to plus 170 and stage 175 factors may also be included in as data 130 to define to additional factors considered in determining whether an examination should be scheduled. Additionally, scheduling data 130 may be included as data 130 in the database 120 to organize presently scheduled examinations, as well as determine availability for new examinations to be scheduled.

Zones may be used to describe the area of the retina that may be affected by ROP. The zones may be centered on the optic nerve and definable as a circle with a radius extending from the optic nerve. Stage may be used to specific the severity of the symptoms, which are typically applicable between the vascularized and avascular retina. Plus disease may signify a significant level of vascular dilation observed at the posterior retinal vessels. The presence of the plus disease may result in increased blow flow through the retina.

In addition to data 130, rules 125 may also be included in the database 120 to define the operation of the system. Rules for an initial examination 135 may define conditions indicative of an initial examination being necessary. Similarly, rules for a follow-up examination 140 may define conditions indicative of a subsequent or follow-up examination being necessary. Local rules 145 may define modifications of the rules 125 in relation a geographic location that the system is being operated. Local rules 145 may also be defined to include policies or procedures particular to the medical office or facility in which the system is being used. Additionally, monitoring rules 150 may be included to define the parameters by which a patient may be monitored while undergoing medical care and/or after being discharged.

A rules engine 185 may be operated by the system to compare the data 130 with the rules 125 to determine a result 190. The result 190 may indicate whether an examination should be scheduled. The result 190 may be analyzed by the system and/or a medical practitioner to determine whether an examination will actually be scheduled. The rules engine 185 may be performed by a computerized device including a processor and memory, an example of which will be provided later in the disclosure.

The database 120 may be connected to a network 110. In an embodiment of the present invention, at least part of the database 120 may be accessible over the network 110. For example, patient data 155 for a particular hospital system may be included in a centralized database 120 accessible over a network 110. A local instance of the system operated at a branch of the hospital system may include the additional data 130, along with the rules 125 to be operated by the rules engine 185, in a local database 120. The system could access the patient data 155 over the network 110, which it may include with additional data 130 to be compared to the rules 125 using the rules engine 185. Additionally, information may be storable on a database 120 connected using a network 110. A person of skill in the art will appreciate that information may be accessible across various physically separated, but electronically communicative, databases 120 as included within the scope and spirit of the present invention.

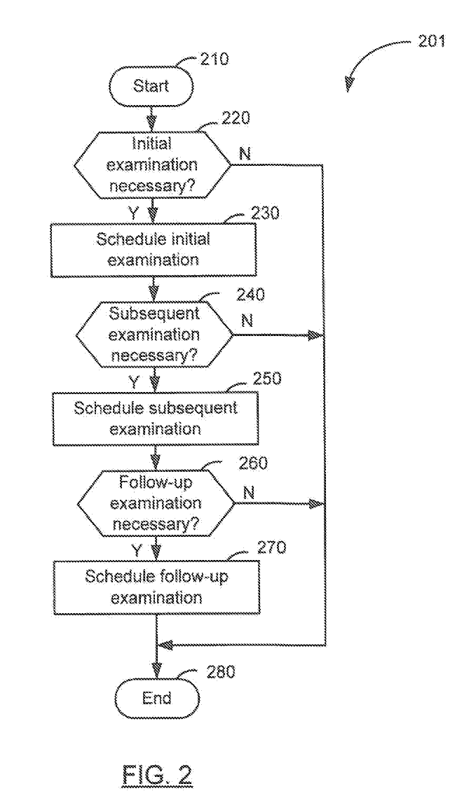

Referring now to flowchart 201 of FIG. 2, an illustrative operation of the system, according to an embodiment of the present invention, will now be discussed. Starting at Block 210, information relating to a patient may be analyzed to determine whether an initial examination will be necessary (Block 220). If it is determined that no initial examination will be necessary, the operation may end at Block 280. However, if it determined that an initial examination will be required at Block 220, the initial examination may be scheduled at Block 230. The initial examination may ultimately be conducted at the appropriate time as determined by the rules engine in operation and the examination findings are recorded and saved in the infant patient's electronic file within the database.

After the initial examination has been administered and the findings have been entered into the system, it may then be determined whether subsequent examination will be necessary (Block 240). If it is determined that no subsequent examination will be necessary, the operation may end at Block 280. However, if it determined that a subsequent examination will be required at Block 240, the subsequent examination may be scheduled at Block 250.

After the subsequent examination has been administered and the findings have been entered into the system, and after the patient may be discharged from the NICU, it may then be determined whether a follow-up examination will be necessary (Block 260). A follow-up examination may be necessary, for instance, if the patient would benefit from continued observation of the ROP conditions. If it is determined that no follow-up examination will be necessary, the operation may end at Block 280. However, if it determined that a follow-up examination will be required at Block 270, the follow-up examination may be scheduled at Block 250.

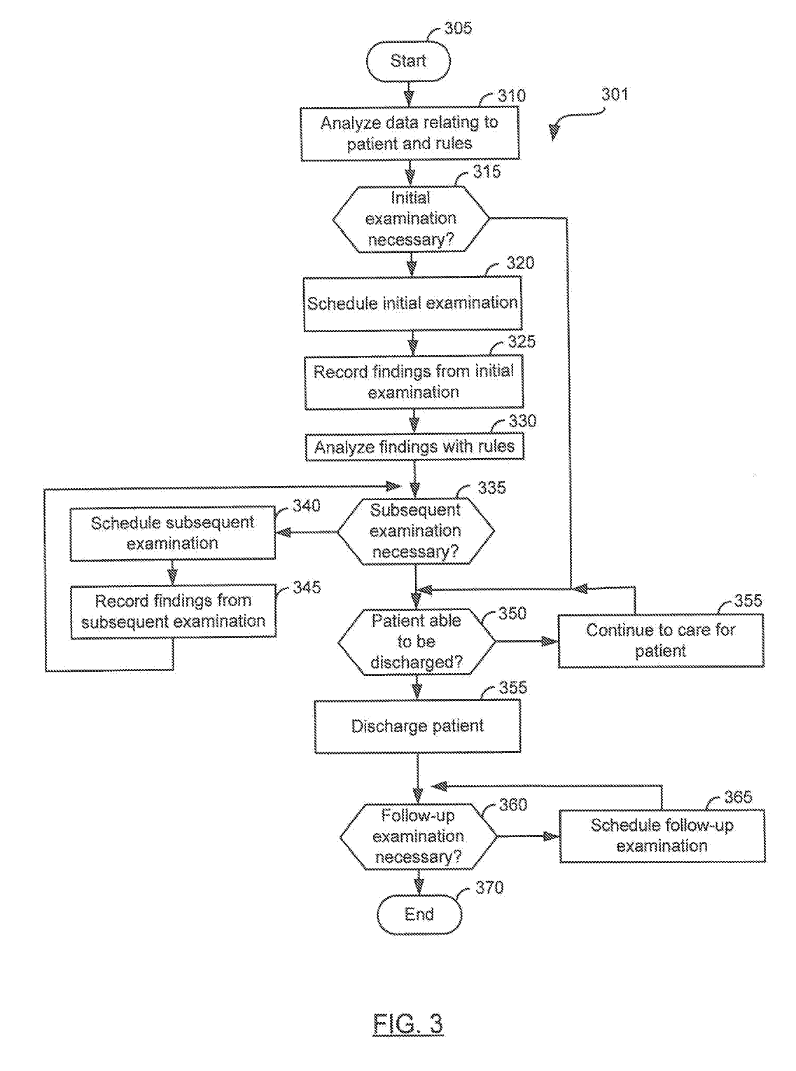

Next, referring to flowchart 301 of FIG. 3, we have a more detailed overview of the system of the present invention. Starting at Block 305, data relating to a patient and rules, which may be stored in the database, may be analyzed by the system (Block 310). The system may then determine whether an initial examination will be necessary (Block 315). If it is determined that no initial examination will be necessary, the operation may continue to at Block 350, which will be discussed in more detail later in this example. However, if it is determined that an initial examination will be required at Block 315, the initial examination may be scheduled at Block 320.

After the initial examination has been administered and the findings have been entered into the system, the findings may be examined with the rules (Block 330). The system may then be determined whether subsequent examination will be necessary at Block 335. This determination may be made, for example, by analyzing the findings of the initial examination. If it is determined that no subsequent examination will be necessary, the operation may continue to at Block 350, which will be discussed in more detail later in this example. However, if it is determined that a subsequent examination will be required at Block 335, the subsequent examination may be scheduled at Block 340.

After the subsequent examination has been administered and the findings have been entered into the system, the findings may be examined with the rules (Block 345). The system may then again be determined whether subsequent examination will be necessary at Block 335.

If it is determined that no initial examination is necessary at Block 315, or if it is determined that no subsequent examination is necessary at Block 335, the operation may continue to determine whether the patient may be discharged at Block 350. If the patient may not be discharged, the medical professionals, for example, in the NICU, may continue to care for patient (Block 355). The operation may then continue back to Block 350, wherein it will again be determined whether the patient may be discharged. In some circumstances it is certainly possible that the infant patient will no longer require attention for ROP but may still not be capable of being discharged from the NICU, or the hospital or medical facility more generally.

If it is determined at Block 350 that the patient may be discharged, the patient may be discharged (Block 355). It may then be determined whether a follow-up examination will be necessary for the patient at Block 360. A follow-up examination may be administered at some point after the patient has been discharged from a medical facility, for example, the NICU. If it is determined at Block 360 that a follow-up examination will be necessary at Block 360, the follow-up examination may be scheduled (Block 365). The operation will then return to Block 360, wherein it may again be determined whether a follow-up examination will be necessary. If it is determined that no follow-up examination will be necessary at Block 360, the operation may terminate (Block 370.)

According to an embodiment of the present invention, the scheduling may be performed substantially automatically. For example the system may access a schedule from the database, which may include the appointment slots available for the NICU. It may then be determined a range of available openings in the schedule, in which an examination may be scheduled. Available openings may simply include time periods wherein appointments may not yet be scheduled. It may also be determined a priority for which patients should be scheduled within the range of available openings. Priority may be based on a plurality of factors, including, for example, birth weight, gestational age, geographic location, ethnic background, findings of previous examinations, or other factors.

The system may then compare the range of available openings with the priority associated with the patients to determine which patient should be scheduled for available times. After this comparison, the examinations may be scheduled for the patients.

Although not shown, based on the finding of the conducted examination determination will be made whether still further post-NICU follow-ups are necessary or desirable. If additional follow-up examinations are necessary or desirable as specified by the selected rules engine the exams would be scheduled, conducted and any findings recorded. This loop of scheduling, conducting examinations and recording findings continues until such time as additional follow-up medical care and evaluation for ROP is no longer necessary 380.

With respect to discharge from the NICU, although not shown, it is certainly possible that the infant patient may be discharged from one hospital or NICU and admitted to another hospital or NICU. The patient's medical records would transfer to the subsequent hospital and the procedures for scheduling examinations, recording findings and determining whether follow-up evaluations within the hospital or NICU are necessary or desirable.

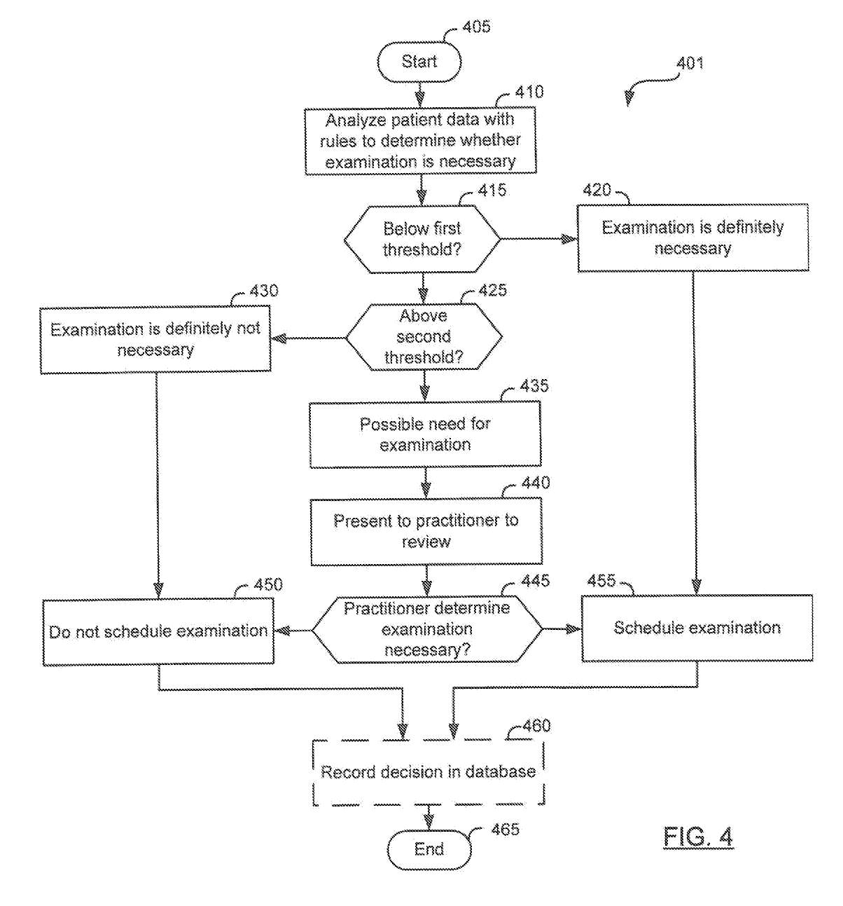

Next, referring to flowchart 401 of FIG. 4, what is shown is an overview of the system that generally illustrates the thresholds contained within the specified rules that are used by the system to determine whether an examination and care for ROP is necessary or desirable. ROP is a progressive eye disease that affects babies that have been born prematurely, however, not all babies born prematurely will develop ROP or even need care and/or evaluation. The primary objective of the present invention is to facilitate the determination of which premature babies require care and/or evaluation, and a system for monitoring progress so as to ensure that those continuing to need care and/or evaluation receive appropriate care and/or evaluation in a timely manner.

At some point after entry of a premature baby into the NICU various vital statistics will be taken. This patient data may be obtained and entered into the system, either directly or via sharing with a database or electronic medical records system already utilized by the NICU. There are any number vital statistics, observational presentations and/or combinations of statistics and observational presentations that can trigger the scheduling of an exam. In one specific embodiment infant patients with a GA of less than 31 weeks (i.e., 30 weeks 6 days) are automatically scheduled to have an ROP examination. If these default rules are implemented an infant patient having a GA of 31 weeks or greater would not have an ROP examination scheduled.

Skilled artisans will appreciate that the example illustrated in FIG. 4 is not specific to the initial, subsequent, or follow-up examinations. Those of skill in the art will also appreciate that the illustrative method disclosed therein may be applied to virtually all types of examination.

FIG. 4, starting at Block 405, illustrates an initial analysis of patient data with the rules to determine wither an examination is necessary (Block 410). From that analysis, the system may inquire whether a result of the analysis is below a first threshold (Block 415), If so, it may be determined that an examination is definitely necessary (Block 420). This determination may trigger the scheduling of an exam (Block 455).

Also shown is inquiry into whether the results from the analysis are above a second threshold (Block 425). If so, it may be determined that an examination is not necessary (Block 430). This determination may trigger no examination being scheduled (Block 450).

If it is determined that the results from the analysis are not below the first threshold at Block 415, and are not above the second threshold at Block 425, the system may determine a possible need exists for an examination (Block 435). This determination may be submitted to a medical practitioner to review (Block 440). The medical practitioner may then determine whether the examination is necessary for the patient at Block 445.

If it is determined that an examination is necessary at Block 445, the examination may be scheduled (Block 445). Conversely, if it is determined that no examination is necessary at Block 445, the examination may not be scheduled (Block 450). Whether the examination is scheduled or not at Blocks 445, 450, respectively, the operation may continue to Block 460, wherein it may optionally record the decision in the database. The operation may then terminate at Block 465.

A person of skill in the art will appreciate that additional thresholds may be included in the example of flowchart 401 and be included within the scope of the present invention. For example, an Nth threshold may be defined, where N can be any number and is correlated to the number of individual rules within the specific rules engine. Each of the rules may be used to compare against the premature babies vital statistics and/or observational presentations in order to determine whether an examination is triggered.

If the rules within the specified rules engine do not trigger an examination when compared against the vital statistics and/or observational presentations of the premature baby, the system may determine that an examination is not necessary, such as at Block 450. In an embodiment of the present invention, it may be possible, however, for a medical care provider, such as a pediatric ophthalmologist, to override the system. In the event that the system is overridden and an examination is scheduled, the exam may be conducted within the time frame determined by the individual or individuals who initiated the system override.

In a second embodiment focusing on GA, the invention will allow for additional consideration of extrinsic information existing in the medical records of the infant patient to further be considered when determining whether to engage in an ROP examination. For example, infant patients with a GA of less than 31 weeks may have an ROP examination automatically scheduled, while those with a GA of between 31 weeks and 32 weeks plus 6 days would have an ROP examination scheduled if and only if there are risk factors present, such as the mother is a known drug user. In this implementation of the rules an infant patient with a GA of 33 weeks or greater would not have an ROP examination scheduled.

Another illustration of a threshold can be seen by reference to the BW variable. In one specific embodiment infant patients with a birth weight (BW) of less than 1500 grams are automatically scheduled to have an ROP examination, while those weighing 1500 grams or more are not scheduled. In another embodiment that focuses on BW, automatic ROP examinations are scheduled when the infant patient's BW is less than 1500 grams and only scheduled in the situation where there are other risk factors if the BW is 1500 grams but less than 2000 grams. If the BW of the infant patient were 2000 grams or greater then no ROP examination would be scheduled.

The second embodiment of the GA variable focus implementation and the second embodiment of the BW variable focus implementation are illustrative of, for among other things, the geographical specific rules engine that would allow a different set of default rules to govern in a particular geographical region.

Thus the system of the present invention is, in certain embodiments, may be configured to rely upon geo-location data to select the appropriate rules engine suitable for the specific geographical location. This geo-location data can be received through GPS satellites or similar technology, or may rely upon the IP address, which can be tied to a geographical location. Regardless of how the geo-location is determined the system can access and implement the appropriate default rules engine for the unique local population. These geographical dictated default rules engines can take into account one or more regional variations in acceptable protocol based on a number of factors, ranging from the peculiarities of the indigenous population or the economic realities of available insurance coverage or even the human resources reality that too few doctors specializing in ROP care are available within the geographical region.

Still further, the geographical dictated default rules engine may be customizable to allow for additional inputs that would trigger the implementation of a different rules engine, recognizing that certain discovered anomalies may relate specifically to ethnicity rather than purely geographical location. In this situation it would be reasonable when in India, for example, to implement the appropriate India default rules, but Westerners traveling in India and seeking medical care may benefit from a default rules engine over-ride that would take into consideration the unique circumstances and proper, prudent protocols of the foreigner in a distant country. The medical care sought may include an initial examination for ROP being properly administered to an infant patient.

Similarly, these second illustrative implementations of the GA and BW may be further modified (i.e., narrowed or broadened) to account for unique circumstances in a population or sub-population, or even tailored to the particular insurance coverage available. In the case of a sub-population, for example, the rules engine may be further narrowed based on ethnicity, taking into account that not all patients geographically located in a particular region will be of the same ethnicity, which may affect the recommended diagnostic, treatment and follow-up regimen.

Still further versions of the invention may combine both GA and BW factors when determining whether to schedule an ROP examination. Moreover, because the system is fully configurable the hospital, NICU and/or pediatric ophthalmologist may create their own specific user defined rules. For example:

BW<user defined and GA less than 31 weeks=ROP Exam

BW<user defined and GA 31 weeks to 32 weeks, 6 days=ROP Exam

BW<user defined and GA of any=ROP Exam

BW>=user defined and GA less than 31 weeks=ROP Exam

BW>=user defined and GA 31 weeks or greater=no ROP Exam

When scheduling an initial ROP examination after the initial evaluation the generic default rules engine is configured as follows:

If GA was less than 28 weeks, schedule exam for what would have been the 31^{st} week of gestation.

If GA was 28 weeks to 28 weeks, 6 days, schedule exam for what would have been the 32^{nd} week of gestation.

If GA was 29 weeks to 29 weeks, 6 days, schedule exam for what would have been the 33^{rd} week of gestation.

If GA was 30 weeks to 30 weeks, 6 days, schedule exam for what would have been the 34^{th} week of gestation.

If GA was 31 weeks to 31 weeks, 6 days, schedule exam for what would have been the 35^{th} week of gestation.

If GA was 32 weeks to 32 weeks, 6 days, schedule exam for what would have been the 36^{th} week of gestation.

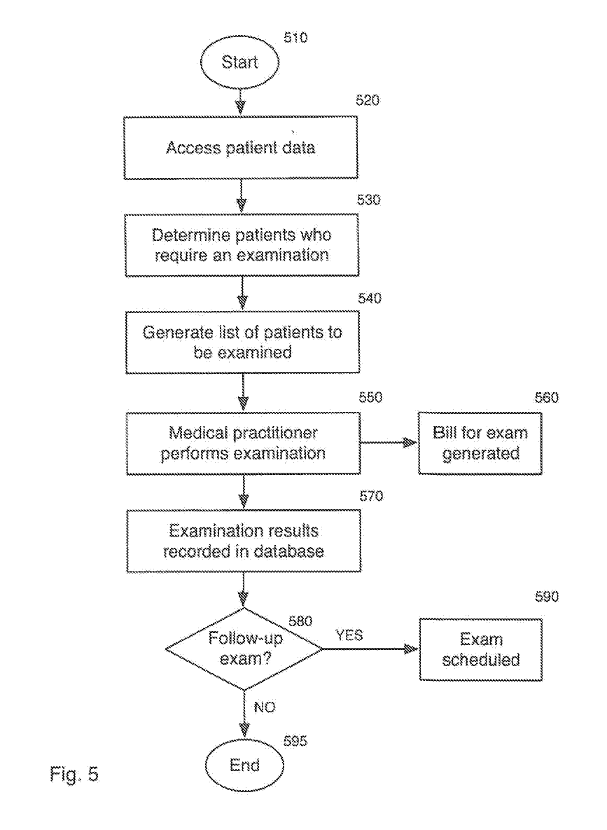

Turning now to FIG. 5, what is shown focuses on a particular aspect of the present invention. In certain embodiments of the present invention upon commencement, starting at Block 510, the patient data may be accessed by a user, ordinarily by a nurse or other member of the NICU staff (Block 520). The system may then determine patients that may require an examination (Block 530). The purpose of accessing the patient data is to generate a list of patients to be examined for ROP by the pediatric ophthalmologist (Block 540). Additionally, the patient data may be accessed to generate a report relating to the information, for example, about the patient and findings from previously administered examinations.

The medical practitioner, typically a pediatric ophthalmologist, may then perform the examination on the patients as scheduled (Block 550). Optionally, a bill may be generated relating to the examination once it has been performed (Block 560). After the operation of Block 550, the findings of the examination may be recorded in the database (Block 570). Upon completion of the examination, inquiry may be made as to whether a follow-up exam may be necessary or required 580. Based on the rules definable by the rules engine, a follow-up examination may be scheduled or determined to be unnecessary at Block 590.

Although not shown, it is certainly within the purview of the pediatric ophthalmologist to override the system to schedule a follow-up examination even though the rules engine suggests that an examination is not necessary or desirable. Additionally, an alert may be generated to inform a user of an event or other status of the system, which may result by comparing the data with the rules. The alert may be delivered to the user using an interface, for example. As a non limiting example of an alert, a message may be generated for an ophthalmologist that may have missed an examination.

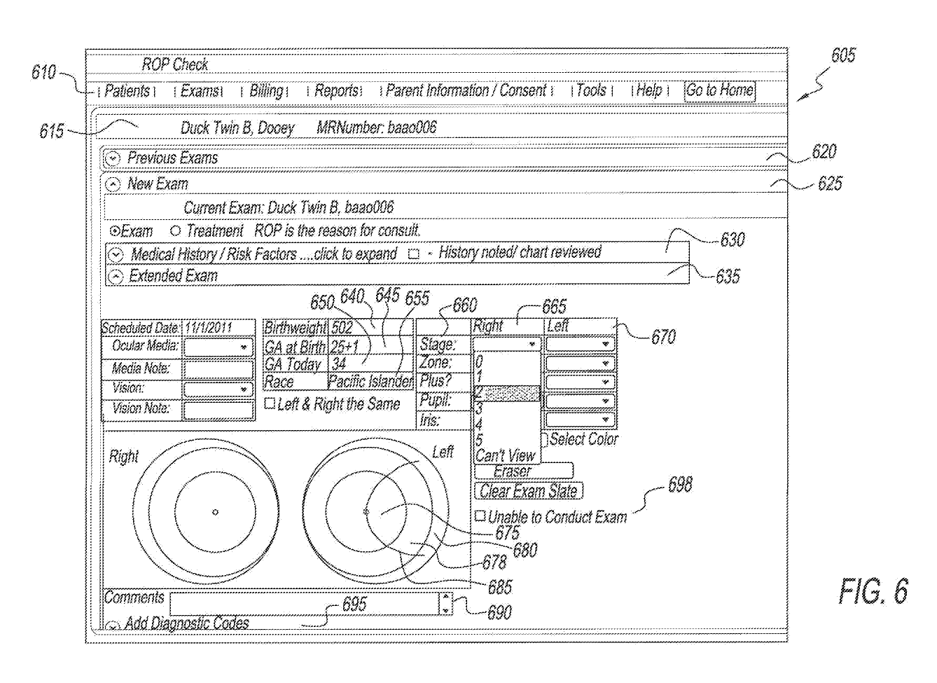

FIG. 6 shows an illustrated screenshot 605 depicting one particular visual implementation of a specific version of the system. While shown here in one particular implementation the graphical user interface can take on numerous different variations, all of which are specifically intended to be covered by this disclosure.

As shown, FIG. 6 is useful to illustration how examination results are entered into the system. There is a navigation menu 610 at the top, under where the name and reference number associated with the patient are displayed 615. Collapsible browser tabs are shown with Previous Exams 620 and Medical History 630 being in collapsed form, while New Exam 625 and Extended Exam 635 are shown in expanded form.

Under Extended Exam 635 critical data relative to the rules engine may be entered, specifically birth weight 640, GA at birth 645, GA at time of examination 650 and race 655 (sometimes referred to herein as ethnicity). The pediatric ophthalmologist, or his/her designee, can add data and observational information from the examination into the system, such as stage 660, zone, plus, pupil and iris descriptions for the right eye 665 and/or the left eye 670. It is also possible for the pediatric ophthalmologist to draw the blood vessels observed 695 in the right and/or left eye. This can be accomplished by using the mouse or other input device. The line drawn to represent the blood vessels 695 can vary in thickness to provide a record of the closest approximation possible. In certain other embodiments images may be taken of the eyes and uploaded to the system for future reference. To facilitate the drawing the blood vessels 695 the system presents a right and left eye diagram. With respect to the left eye, for illustration purposes, zone 1 is shown as 675, zone 2 is 678, zone 3 is 680, and zone 4 is 685.

FIG. 6 also shows that the system allows the pediatric ophthalmologist to enter comments or findings in text 690. The ophthalmologist may also indicate that he/she was unable to conduct an examination by, for example, selecting a check box labeled as “Unable to Conduct Exam” 698. This could also be accomplished through the use of drop down menu selections or drop down menu selections in addition to text 690. Diagnostic codes 695 are also incorporated with the system. These diagnostic codes may include medical codes, which may be standardized for use through medical practice. Examples of medical codes may include SNOMED, IHTSDO, MEDCIN, HL7, or other system of electronic health records that would be apparent to a person of skill in the art.

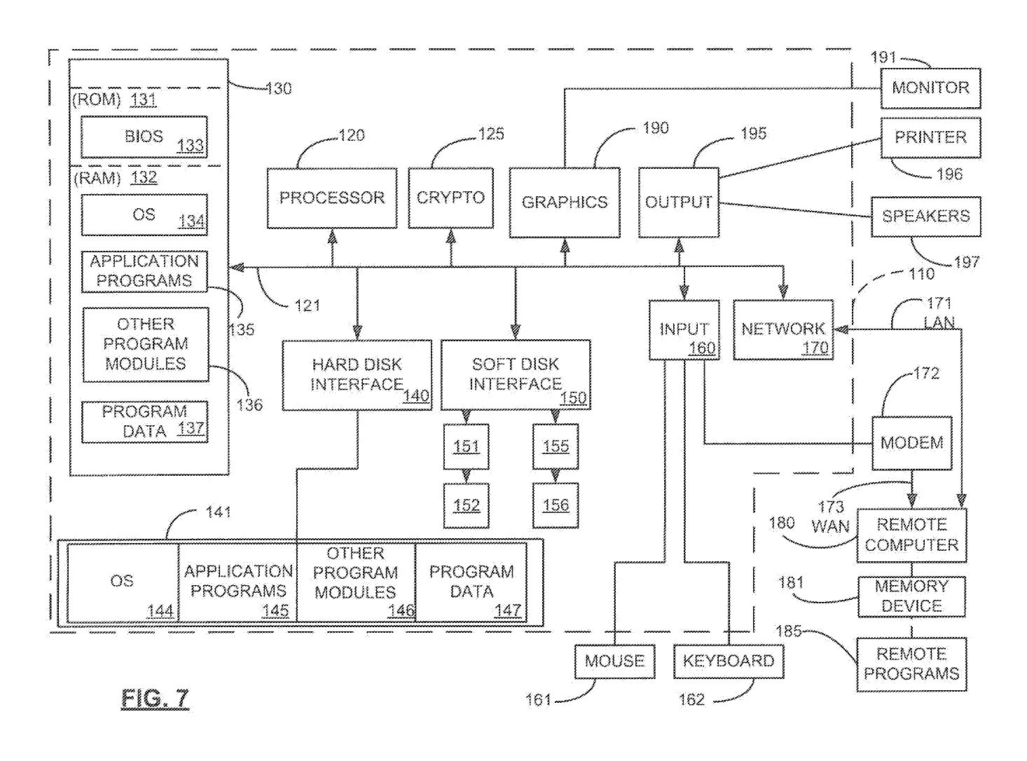

Turning now to the last figure, FIG. 7 illustrates a computing device in the form of a computer 110, which is capable of performing one or more computer-implemented steps in practicing the method aspects of the present invention. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 110 may also include a cryptographic unit 125. Briefly, the cryptographic unit 125 has a calculation function that may be used to verify digital signatures, calculate hashes, digitally sign hash values, and encrypt or decrypt data. The cryptographic unit 125 may also have a protected memory for storing keys and other secret data. In other embodiments, the functions of the cryptographic unit may be instantiated in software and run via the operating system.

A computer 110 typically includes a variety of computer readable media. Computer readable media can be any available media that can be accessed by a computer 110 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 7 illustrates an operating system (OS) 134, application programs 135, other program modules 136, and program data 137.

The computer 110 may also include other removable/non-removable, volatile/nonvolatile computer storage media. By way of example only, FIG. 7 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives, and their associated computer storage media discussed above and illustrated in FIG. 7, provide storage of computer readable instructions, data structures, program modules and other data for the computer 110. In FIG. 7, for example, hard disk drive 141 is illustrated as storing an OS 144, application programs 145, other program modules 146, and program data 147. Note that these components can either be the same as or different from OS 134, application programs 135, other program modules 136, and program data 137. The OS 144, application programs 145, other program modules 146, and program data 147 are given different numbers here to illustrate that, at a minimum, they may be different copies. A user may enter commands and information into the computer 110 through input devices such as a keyboard 162 and cursor control device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 7. The logical connections depicted in FIG. 7 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 7 illustrates remote application programs 185 as residing on memory device 181.

The communications connections 170 and 172 allow the device to communicate with other devices. The communications connections 170 and 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

According to an embodiment of the present invention, the system may be creatable using, for example, but not intended as a limitation, Microsoft's Visual C# .NET development environment. Such a computer program product would be suitable for execution on a computer 110 having, for example, but not intended as a limitation, one of Microsoft's Windows family, Google's Android, or Apple's Mac OSX family of operating systems loaded into memory 134. A person having skill in the art, after having the benefit of this disclosure would recognize that many other development platforms might be used to create a system, which may be executable with many other operating systems, but that still embody the present invention. As such, the following disclosure is provided merely for explanatory purposes and should in no way limit the present invention to embodiments that are created using the aforementioned development platform or for use with the aforementioned operating systems.

According to an additional embodiment, the rules engine may be comprised of a plurality of rules engines, each task able with differing analyses. In an example with two rules engines, a first rules engine may use the birth weight and gestational age to calculate the date of the first exam. A second rules engine uses the stage, zone, and plus to calculate the date of the follow up exam. Both configurable rules engines allow for a hospital to implement standardized care criteria such as the AAP guidelines or to customize their own guidelines based on ROP factors that are specific to the population it serves. The algorithms that power the rules engines allow for criteria that may be absent from the AAP guidelines such as an “if necessary” category, geolocation, and ethnicity. Using the invention, a NICU may want to flag a patient as “if necessary” if the patient's birth weight or gestational age is within a certain range. An “if necessary” patient is one that should have its first exam scheduled manually by the NICU or a pediatric ophthalmologist, rather than automatically using the software, due to co-existing risk factors such as infection or exposure to narcotics while in the womb.

In the foregoing claims, a series of elements may be preceded by the phrase “at least one of.” This style for listing elements is intended to define a list of elements from which, one element, a combination of elements, or all elements may be selected. The list preceded by “at least one of” is not intended to solely require at least one of every listed item.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What is claimed is:

1. A method for determining a need for an examination for a medical condition comprising:
retrieving data from a database, at least part of the data including information about a patient, wherein at least part of the information about the patient included in the database is definable by a user;
retrieving rules stored in the database relating to the need for the examination of the medical condition by a specialist practitioner;
comparing the data with the rules to determine a need for an initial examination, wherein determining the need for the initial examination includes making at least one of a determination of the need for the initial examination, a determination of no need for the initial examination, and a determination of a possible need for the initial examination;
wherein the determination of the need for the initial examination is defined as results of a comparison of the data and the rules being below a first threshold level resulting in the initial examination being scheduled;
wherein the determination of no need for the initial examination is defined as the results of the comparison of the data and the rules being above a second threshold level;
wherein the determination of the possible need for the initial examination is defined as the results of the comparison of the data and the rules resulting between the first threshold level and the second threshold level resulting in presentation of the determination of the possible need for the initial examination to a medical professional to decide whether the initial examination should be scheduled;
wherein findings from the initial examination are storable in the database;
wherein the findings from the initial examination are retrievable from the database to be compared with the rules to determine a need for a subsequent examination, wherein determining the need for the subsequent examination includes making at least one of a determination of the need for the subsequent examination, a determination of no need for the subsequent examination, and the determination of a possible need for the subsequent examination;
wherein the determination of the need for the subsequent examination is defined as results of the comparison of the findings from the initial examination and the rules being below a first threshold level resulting in a subsequent examination being scheduled;
wherein the determination of no need for the subsequent examination is defined as the results of the comparison of the findings from the initial examination and the rules being above a second threshold level;
wherein the determination of the possible need for the subsequent examination is defined as the results of the comparison of the findings from the initial examination and the rules being between the first threshold level and the second threshold level resulting in presentation of the determination of the possible need for the subsequent examination to the medical professional to decide whether the initial examination should be scheduled;
wherein findings from the subsequent examination are storable in the database;
wherein medical codes associated with the findings are storable in the database;
wherein the rules are managed by a rules engine operated on a computerized device with a processor and memory and wherein at least part of the data is accessible using an interface.

2. A method according to claim 1 wherein the medical condition is associated with retinopathy of prematurity.

3. A method according to claim 2 wherein the information compared to the rules to determine whether the initial examination is necessary includes birth weight and gestational age, and wherein the information compared to the rules to determine whether the subsequent examination is necessary relate to the medical condition by stage, zone, and plus.

4. A method according to claim 1 wherein the patient is selectively discharged following the examination; wherein the findings are compared with the rules to determine whether a follow-up examination is necessary for the patient that has been discharged; wherein the follow-up examination that is necessary is scheduled for the patient that has been discharged; and wherein the follow-up examination that is possibly necessary is presented to the medical professional to decide wither the follow-up examination should be scheduled.

5. A method according to claim 4 further comprising generating a follow-up communication with the patient that has been discharged, a response to the follow-up communication being recordable in the database.

6. A method according to claim 1 wherein scheduling the examination occurs substantially automatically and further comprises:
accessing a schedule from the database;
determining a range of available openings for the examination, the examination being defined to be the initial examination or the subsequent examination;
determining a priority for the patient;
comparing the range of available openings with the priority to determine an appointment for the examination; and
scheduling the examination at the appointment.

7. A method according to claim 1 wherein at least part of the database is accessible over a network.

8. A method according to claim 1 wherein custom rules are definable to supplement the rules and are compared with the data to affect determining whether the examination is necessary, the custom rules being storable in the database.

9. A method according to claim 8 wherein the custom rules relate to a geographic location of the patient.

10. A method according to claim 1 wherein an alert generated from comparing the data with the rules is transmittable using the interface.

11. A method according to claim 10 wherein the alert informs the user that the examination is necessary for the patient.

12. A method according to claim 1 wherein reports are selectively generated to include data relating to the patient and the findings.

13. A method according to claim 1 wherein the data relating to the patient and the findings are transferable to an alternate practitioner, and wherein the data that is transferred is selectively monitored and recordable in the database.

14. A method for determining a need for an examination for retinopathy of prematurity comprising:
retrieving data from a database, at least part of the data including information about a patient, wherein at least part of the information about the patient included in the database is definable by a user;
retrieving rules stored in the database relating to the need for the examination of the medical condition by a pediatric ophthalmologist; and
comparing the data including information relating to birth weight and gestational age of the patient with the rules to determine a need for an initial examination, wherein determining the need for the initial examination includes making at least one of a determination of the need for the initial examination, a determination of no need for the initial examination, and a determination of a possible need for the initial examination;
wherein the determination of the need for the initial examination is defined as results of a comparison of the data and the rules being below a first threshold level resulting in the initial examination being scheduled;
wherein the determination of no need for the initial examination is defined as the results of the comparison of the data and the rules being above a second threshold level;
wherein the determination of the possible need for the initial examination is defined as the results of the comparison of the data and the rules being between the first threshold level and the second threshold level resulting in presentation of the determination of the possible need for the initial examination to a medical professional to decide whether the initial examination should be scheduled;
wherein findings relating to zone, stage and plus of a patient from the initial examination are storable in the database;
wherein the findings are retrievable from the database to be compared with the rules to determine a need for a subsequent examination, wherein determining the need for the subsequent examination includes making at least one of a determination of the need for the subsequent examination, a determination of no need for the subsequent examination, and the determination of a possible need for the subsequent examination;
wherein the determination of the need for the subsequent examination is defined as results of the comparison of the findings from the initial examination and the rules being below a first threshold level resulting in a subsequent examination being scheduled;
wherein the determination of no need for the subsequent examination is defined as the results of the comparison of the findings from the initial examination and the rules being above a second threshold level;
wherein the determination of the possible need for the subsequent examination is defined as the results of the comparison of the findings from the initial examination and the rules being between the first threshold level and the second threshold level resulting in presentation of the determination of the possible need for the subsequent examination to the medical professional to decide whether the initial examination should be scheduled;
wherein findings from the subsequent examination are storable in the database;
wherein scheduling the examination occurs substantially automatically and further comprises:
accessing a schedule from the database,
determining a range of available openings for the examination, the examination being defined to be the initial examination or the subsequent examination,
determining a priority for the patient,
comparing the range of available openings with the priority to determine an appointment for the examination, and
scheduling the examination at the appointment;
wherein medical codes associated with the findings are storable in the database;
wherein the rules are managed by a rules engine operated on a computerized device with a processor and memory and wherein at least part of the data is accessible using an interface.

15. A method according to claim 14 wherein the patient is selectively discharged following the examination; wherein the findings are compared with the rules to determine whether a follow-up examination is necessary for the patient that has been discharged; wherein the follow-up examination that is necessary is scheduled for the patient that has been discharged; and wherein the follow-up examination that is possibly necessary is presented to the medical professional to decide wither the follow-up examination should be scheduled.

16. A method according to claim 15 further comprising generating a follow-up communication with the patient that has been discharged, a response to the follow-up communication being recordable in the database.

17. A method according to claim 14 wherein at least part of the database is accessible over a network.

18. A method according to claim 14 wherein custom rules are definable to supplement the rules and are compared with the data to affect determining whether the examination is necessary, the custom rules being storable in the database.

19. A method according to claim 14 wherein an alert generated from comparing the data with the rules is transmittable using the interface.

20. A method according to claim 19 wherein the alert informs the user that the examination is necessary for the patient.

21. A method according to claim 14 wherein reports are selectively generated to include data relating to the patient and the findings.

22. A method according to claim 14 wherein the data relating to the patient and the findings are transferable to an alternate practitioner, and wherein the data that is transferred is selectively monitored and recordable in the database.

23. A method according to claim 18 wherein the custom rules relate to a geographic location of the patient.

24. A system for determining a need for an examination for a medical condition comprising:
a computerized device including a processor and a memory;
a database to include data, at least part of the data including information about a patient, wherein at least part of the information about the patient is definable by a user, and wherein at least part of the data is accessible using an interface;
a rules engine operated by the computerized device to manage rules, wherein the rules engine:
retrieves at least part of the data from the database,
retrieves the rules stored in the database relating to the need for the examination of the medical condition by a specialist practitioner,
compares the data retrieved from the database with the rules to determine a need for an initial examination, wherein determining the need for the initial examination includes making at least one of a determination of the need for the initial examination, a determination of no need for the initial examination, and a determination of a possible need for the initial examination,
wherein the determination of the need for the initial examination is defined as results of a comparison of the data and the rules being below a first threshold level resulting in the initial examination being scheduled;
wherein the determination of no need for the initial examination is defined as the results of the comparison of the data and the rules being above a second threshold level;
wherein the determination of the possible need for the initial examination is defined as the results of the comparison of the data and the rules being between the first threshold level and the second threshold level resulting in presentation of the determination of the possible need for the initial examination to a medical professional to decide whether the initial examination should be scheduled;
wherein findings from the initial examination are storable in the database;
wherein the findings from the initial examination are retrievable from the database to be compared with the rules to determine a need for a subsequent examination, wherein determining the need for the subsequent examination includes making at least one of a determination of the need for the subsequent examination, a determination of no need for the subsequent examination, and the determination of a possible need for the subsequent examination;
wherein the determination of the need for the subsequent examination is defined as results of the comparison of the findings from the initial examination and the rules being below a first threshold level resulting in a subsequent examination being scheduled;
wherein the determination of no need for the subsequent examination is defined as the results of the comparison of the findings from the initial examination and the rules being above a second threshold level; and
wherein the determination of the possible need for the subsequent examination is defined as the results of the comparison of the findings from the initial examination and the rules being between the first threshold level and the second threshold level resulting in presentation of the determination of the possible need for the subsequent examination to the medical professional to decide whether the initial examination should be scheduled;
wherein findings from the subsequent examination are storable in the database; and
wherein medical codes associated with the findings are storable in the database.

25. A system according to claim 24 wherein the medical condition is associated with retinopathy of prematurity.

26. A system according to claim 25 wherein the information compared to the rules to determine whether the initial examination is necessary includes birth weight and gestational age, and wherein the information compared to the rules to determine whether the subsequent examination is necessary relate to the medical condition by stage, zone, and plus.

27. A system according to claim 24 wherein the patient is selectively discharged following the examination; wherein the findings are compared with the rules to determine whether a follow-up examination is necessary for the patient that has been discharged; wherein the follow-up examination that is necessary is scheduled for the patient that has been discharged; and wherein the follow-up examination that is possibly necessary is presented to the medical professional to decide wither the follow-up examination should be scheduled.

28. A system according to claim 27 wherein a follow-up communication is selectively generated for the patient that has been discharged, a response to the follow-up communication being recordable in the database.

29. A system according to claim 24 wherein scheduling the examination occurs substantially automatically by accessing a schedule from the database, determining a range of available openings for the examination, the examination being defined to be the initial examination or the subsequent examination, determining a priority for the patient, comparing the range of available openings with the priority to determine an appointment for the examination, and scheduling the examination at the appointment.

30. A system according to claim 24 wherein at least part of the database is accessible over a network.

31. A system according to claim 24 wherein custom rules are definable to supplement the rules and are compared with the data to affect determining whether the examination is necessary, the custom rules being storable in the database.

32. A system according to claim 31 wherein the custom rules relate to a geographic location of the patient.

33. A system according to claim 24 wherein an alert generated from comparing the data with the rules is transmittable using the interface.

34. A system according to claim 32 wherein the alert informs the user that the examination is necessary for the patient.

35. A system according to claim 24 wherein reports are selectively generated to include data relating to the patient and the findings.

36. A system according to claim 24 wherein the data relating to the patient and the findings are transferable to an alternate practitioner, and wherein the data that is transferred is selectively monitored and recordable in the database.

37. A method for determining a need for an examination for a medical condition comprising:
retrieving data from a database, at least part of the data including information about a patient, wherein at least part of the information about the patient included in the database is definable by a user;
retrieving rules stored in the database relating to the need for the examination of the medical condition by a specialist practitioner, the rules including default rules and custom rules to supplement the default rules; and
comparing the data with the rules to determine a need for an initial examination;
wherein the custom rules are selectable in an override to replace the default rules for comparison with the data;
wherein determining the need for the initial examination includes making at least one of a determination of the need for the initial examination, a determination of no need for the initial examination, and a determination of a possible need for the initial examination;
wherein the determination of the need for the initial examination is defined as results of a comparison of the data and the rules being below a first threshold level resulting in the initial examination being scheduled;
wherein the determination of no need for the initial examination is defined as the results of the comparison of the data and the rules being above a second threshold level;
wherein the determination of the possible need for the initial examination is defined as the results of the comparison of the data and the rules being between the first threshold level and the second threshold level resulting in presentation of the determination of the possible need for the initial examination to a medical professional to decide whether the initial examination should be scheduled;
wherein findings from the initial examination are storable in the database.

38. A method according to claim 37:
wherein the findings from the initial examination are retrievable from the database to be compared with the rules to determine a need for a subsequent examination;
wherein determining the need for the subsequent examination includes making at least one of a determination of the need for the subsequent examination, a determination of no need for the subsequent examination, and a determination of a possible need for the subsequent examination;
wherein the determination of the need for the subsequent examination is defined as results of the comparison of the finding from the initial examination and the rules being below a first threshold level resulting in a subsequent examination being scheduled;
wherein the determination of no need for the subsequent examination is defined as the results of the comparison of the finding from the initial examination and the rules being above a second threshold level;
wherein the determination of the possible need for the subsequent examination is defined as the results of the comparison of the finding from the initial examination and the rules being between the first threshold level and the second threshold level resulting in presentation of the determination of the possible need to the medical professional to decide whether the initial examination should be scheduled;
wherein findings from the subsequent examination are storable in the database;
wherein medical codes associated with the findings are storable in the database;
wherein the rules are managed by a rules engine operated on a computerized device with a processor and memory and wherein at least part of the data is accessible using an interface.

39. A method according to claim 37 wherein the medical condition is associated with retinopathy of prematurity; wherein the information compared to the rules to determine whether the initial examination is necessary includes birth weight and gestational age; and wherein the information compared to the rules to determine whether the subsequent examination is necessary relate to the medical condition by stage, zone, and plus.

40. A method according to claim 37 wherein the patient is selectively discharged following the examination; wherein the findings are compared with the rules to determine whether a follow-up examination is necessary for the patient that has been discharged; wherein the follow-up examination that is necessary is scheduled for the patient that has been discharged; and wherein the follow-up examination that is possibly necessary is presented to the medical professional to decide wither the follow-up examination should be scheduled; and further comprising generating a follow-up communication with the patient that has been discharged, a response to the follow-up communication being recordable in the database.

41. A method according to claim 37 wherein scheduling the examination occurs substantially automatically and further comprises:
accessing a schedule from the database;
determining a range of available openings for the examination, the examination being defined to be the initial examination or the subsequent examination;
determining a priority for the patient;
comparing the range of available openings with the priority to determine an appointment for the examination; and
scheduling the examination at the appointment.

42. A method according to claim 37 wherein at least part of the database is accessible over a network.

43. A method according to claim 37 wherein the custom rules relate to a geographic location of the patient.

44. A method according to claim 38 wherein an alert generated from comparing the data with the rules is transmittable using the interface; and wherein the alert informs the user that the examination is necessary for the patient.

45. A method according to claim 37 wherein reports are selectively generated to include data relating to the patient and the findings; wherein the data relating to the patient and the findings are transferable to an alternate practitioner; and wherein the data that is transferred is selectively monitored and recordable in the database.

46. A method for determining a need for an examination for retinopathy of prematurity comprising:
retrieving data from a database, at least part of the data including information about a patient, wherein at least part of the information about the patient included in the database is definable by a user;
determining based on the geographical location of the patient the first set of rules to be applied;
retrieving the first set of rules;
comparing the data including information relating to birth weight and gestational age of the patient with the rules to determine a need for an initial examination, wherein determining the need for the initial examination includes making at least one of a determination of the need for the initial examination, a determination of no need for the initial examination, and a determination of a possible need for the initial examination;
in the event an initial examination is indicated, scheduling the examination automatically, further comprising:
accessing a schedule from the database,
determining a range of available openings for the examination, the examination being defined to be the initial examination or the subsequent examination,
determining a priority for the patient,
comparing the range of available openings with the priority to determine an appointment for the examination, and
scheduling the examination;
wherein the rules are managed by a rules engine operated on a computerized device with a processor and memory and wherein at least part of the data is accessible using an interface.

47. A method according to claim 46 further comprising:
determining whether the first set of geographically indicated rules coinciding with the geographical location of the patient should be applied given the ethnicity of the patient; and
if a determination is made that the first set of geographically indicated rules are not in the best interest of the patient, selecting a second set of rules and overriding the first set of geographically indicated rules.
